(19) United States
(12) Patent Application Publication
(10) Pub. No.: US 2016/0132018 A1
(43) Pub. Date: May 12, 2016

(54) CLEANING DEVICE, CARTRIDGE, METHOD FOR REMANUFACTURING CLEANING DEVICE, AND METHOD FOR REMANUFACTURING CARTRIDGE

(71) Applicant: CANON KABUSHIKI KAISHA, Tokyo (JP)

(72) Inventor: Nobuharu Hoshi, Yokohama-shi (JP)

(21) Appl. No.: 14/935,129

(22) Filed: Nov. 6, 2015

(30) Foreign Application Priority Data
Nov. 10, 2014 (JP) 2014-228476

(51) Int. Cl. G03G 15/00; A47L 1/06; G03G 21/00; B08B 7/00

(52) U.S. Cl. CPC G03G 21/169; B08B 1/001; G03G 21/0011; G03G 21/181

(57) ABSTRACT

In a method for remanufacturing a cleaning device including an photosensitive drum, a cleaning frame unit, a cleaning member configured to clean a surface of the photosensitive drum, and a blade lower sealing member integrally injection molded with the cleaning frame unit and disposed between the cleaning frame unit and the cleaning member, detaching the cleaning member from the cleaning frame unit, cleaning the sealing member, and attaching the cleaning member to the cleaning frame unit, are sequentially performed.

### BACKGROUND OF THE INVENTION

1. Field of the Invention

The present invention relates to a cleaning device used in an electrophotographic image forming apparatus that forms an image on a recording medium, a cartridge that is attachable to and detachable from the electrophotographic image forming apparatus, a method for remanufacturing the cleaning device, and a method for remanufacturing the cartridge.

2. Description of the Related Art

In electrophotographic image forming apparatuses employing an electrophotographic process (hereinafter, referred to as “image forming apparatuses”), an electrophotographic photosensitive member (hereinafter, referred to as “photosensitive drum”) is uniformly charged, and an electrostatic latent image is formed by selectively exposing the photosensitive drum with light. The electrostatic latent image is developed by developer (hereinafter, referred to as “toner”) to be visualized as a toner image. Then, the toner image is transferred onto a recording medium, and by applying heat and pressure, the transferred toner image is fixed on the recording medium, whereby an image is recorded. Such an image forming apparatus requires an operation of supplying the developer and maintenance on various types of process units.

To facilitate the operation of supplying the developer and the maintenance, a process cartridge system has been employed in which a cartridge, formed by integrating all of or at least one of a photosensitive drum, a charging unit, a cleaning unit, a developing device, and the like, is attachable to and detachable from the image forming apparatus. With the process cartridge system, users can replace process cartridges (hereinafter, referred to as “cartridges”) by themselves to maintain the apparatus, so that operability is significantly enhanced.

Since the image forming apparatus provided with such a cartridge forms an image on a recording medium by using toner, the toner in the cartridge is consumed every time the image forming is performed. The process cartridge loses its commercial value once the toner is consumed to such a level that an image with sufficient quality for a user who has purchased the cartridge can no longer be formed. A simple method for remanufacturing the cartridge has conventionally been desired with which the process cartridge that has lost its commercial value, due to the consumption of the toner, can be put into the market again, and there have been some attempts to achieve such a method (see Japanese Patent No. 3126968).

### SUMMARY OF THE INVENTION

According to an aspect of the present invention, a method for remanufacturing a cleaning device including: an image bearing member; a frame configured to rotatably support the image bearing member; a cleaning member fixed to the frame and configured to clean a surface of the image bearing member; and a sealing member integrally injection molded with the frame and disposed between the frame and the cleaning member. The method, sequentially performed, includes detaching the cleaning member from the frame, cleaning the sealing member, and attaching the cleaning member to the frame.

According to another aspect of the present invention, a method for remanufacturing a cleaning device including: an image bearing member; a frame configured to rotatably support the image bearing member; a cleaning member fixed to the frame and configured to clean a surface of the image bearing member; and a sealing member integrally injection molded with the frame and disposed between the frame and the cleaning member. The method, sequentially performed, includes detaching the cleaning member from the frame, fixing an assisting member on the cleaning member, and attaching the cleaning member to the frame in such a manner that the assisting member comes into contact with the sealing member.

According to yet another aspect of the present invention, a method for remanufacturing a cartridge including a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member, and a developing device configured to develop an electrostatic latent image formed on the image bearing member. The method, sequentially performed, includes separating the cartridge into the cleaning device and the developing device, detaching the cleaning member from the frame of the cleaning device, cleaning the sealing member, and attaching the cleaning member to the frame

According to yet another aspect of the present invention, a method for remanufacturing a cartridge including: a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member, and a developing device configured to develop an electrostatic latent image formed on the image bearing member. The method, sequentially performed, includes separating the cartridge into the cleaning device and the developing device, detaching the cleaning member from the frame of the cleaning device, fixing an assisting member to the cleaning member, and attaching the cleaning member to the frame in such a manner that the assisting member comes into contact with the sealing member

According to yet another aspect of the present invention, a cleaning device includes an image bearing member, a frame configured to rotatably support the image bearing member, a cleaning member fixed to the frame and configured to clean a surface of the image bearing member, and a sealing member integrally injection molded with the frame and disposed between the frame and the cleaning member. In the cleaning device, an assisting member is provided between the cleaning member and the sealing member.

According to yet another aspect of the present invention, a cartridge includes a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member, and a developing device configured to develop an electrostatic latent image formed on the image bearing member. In the cartridge, an assisting member is provided between the cleaning member and the sealing member.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an overall configuration of an image forming apparatus main body according to a first exemplary embodiment.

FIG. 2 is a schematic cross-sectional view illustrating a process cartridge according to the first exemplary embodiment.

FIG. 3 is a schematic cross-sectional view illustrating a photosensitive drum unit according to the first exemplary embodiment.

FIG. 4 is a schematic front view illustrating a sealing configuration for a cleaning frame unit according to the first exemplary embodiment.

FIG. 5 is a schematic front view illustrating a state where a cleaning member of the cleaning frame unit is attached, according to the first exemplary embodiment.

FIG. 6 is schematic cross-sectional view illustrating an injection port of a cleaning container, according to the first exemplary embodiment.

FIG. 7 is a perspective view illustrating a state where the cleaning container is set to a resin injection device, according to the first exemplary embodiment.

FIG. 8 is a schematic cross-sectional view illustrating a state where resin is injected to the cleaning container, according to the first exemplary embodiment.

FIG. 9 is a schematic cross-sectional view illustrating a state after resin is injected to the cleaning container, according to the first exemplary embodiment.

FIG. 10 is a perspective view illustrating a state where the photosensitive drum unit and a development unit are separated from each other, according to the first exemplary embodiment.

FIG. 11 is a perspective view illustrating a state where a photosensitive drum, a charging roller, and a cleaning member are detached from the photosensitive drum unit, according to the first exemplary embodiment.

FIG. 12 is a schematic view illustrating a process for cleaning a cleaning container in which the cleaning container is cleaned by removing waste toner, according to the first exemplary embodiment.

FIG. 13 is a schematic view illustrating a blade lower sealing member cleaning process, according to the first exemplary embodiment.

FIG. 14 is a schematic cross-sectional view illustrating a state where the cleaning member is attached to the cleaning container, according to the first exemplary invention.

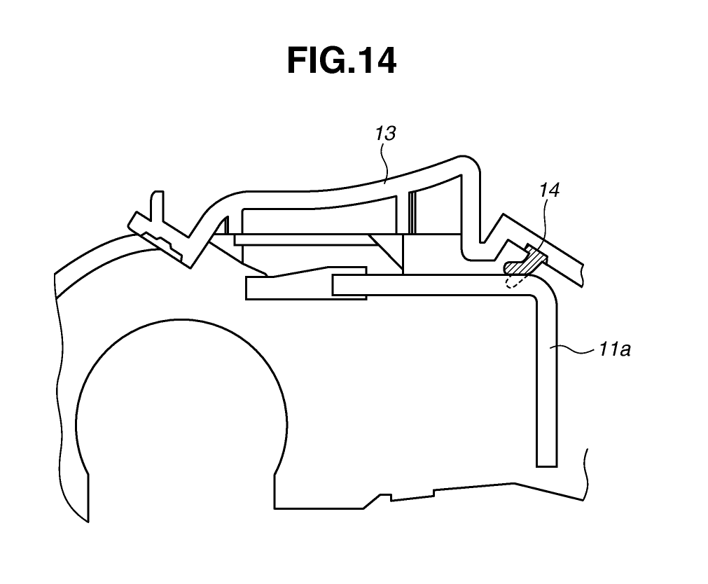

FIG. 15 is a schematic view illustrating a cleaning member cleaning process, according to a second exemplary embodiment.

FIG. 16 is a schematic perspective view illustrating a state where an assisting member is attached on the cleaning member, according to the second exemplary embodiment.

FIG. 17 is a schematic cross-sectional view illustrating a cleaning container, according to the second exemplary embodiment.

FIG. 18 is a schematic perspective view illustrating a cleaning member according to a modified embodiment of the secondary exemplary embodiment.

FIG. 19 is a schematic cross-sectional view illustrating a cleaning container according to the modified embodiment of the secondary exemplary embodiment.

### DESCRIPTION OF THE EMBODIMENTS

An image forming apparatus and a cartridge according to a first exemplary embodiment of the present invention will be described in detail below with reference to the drawings. In the description below, a longitudinal direction of the cartridge matches a rotational axis direction of a photosensitive drum and intersects with a direction in which the cartridge is inserted into an electrophotographic image forming apparatus main body. Left and right sides of the cartridge correspond to the both ends of the cartridge in the longitudinal direction. Upper and lower surfaces of the cartridge are surfaces on upper and lower sides of the cartridge installed in the electrophotographic image forming apparatus main body.

The image forming apparatus (electrophotographic image forming apparatus) forms an image on a recording medium using an electrophotography image forming system. For example, the image forming apparatus includes an electrophotographic copying machine, an electrophotographic printer (such as a laser beam printer or a light-emitting diode (LED) printer), a facsimile device, and the like.

The cartridge (process cartridge) is formed by integrating a process unit, including at least one of a charging unit, a developing unit, and a cleaning unit, with the photosensitive drum, and is attachable to and detachable from the image forming apparatus main body.

### (Overall Configuration)

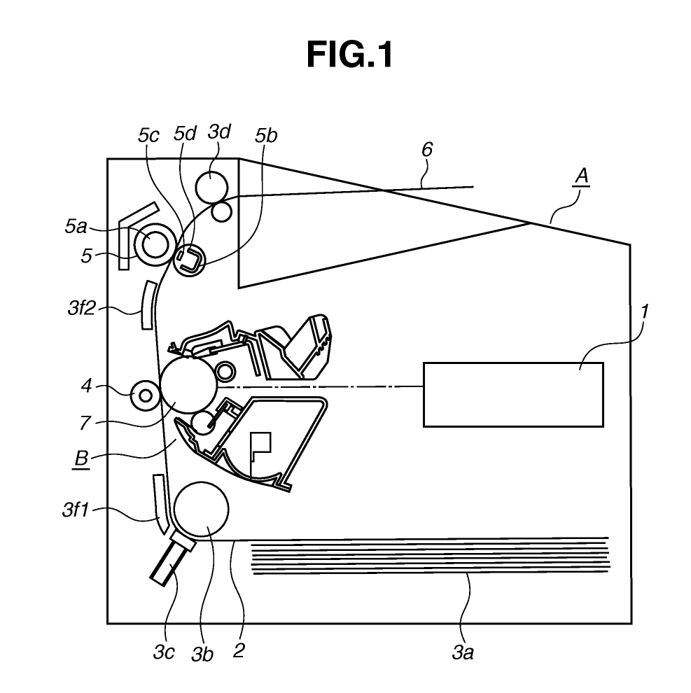

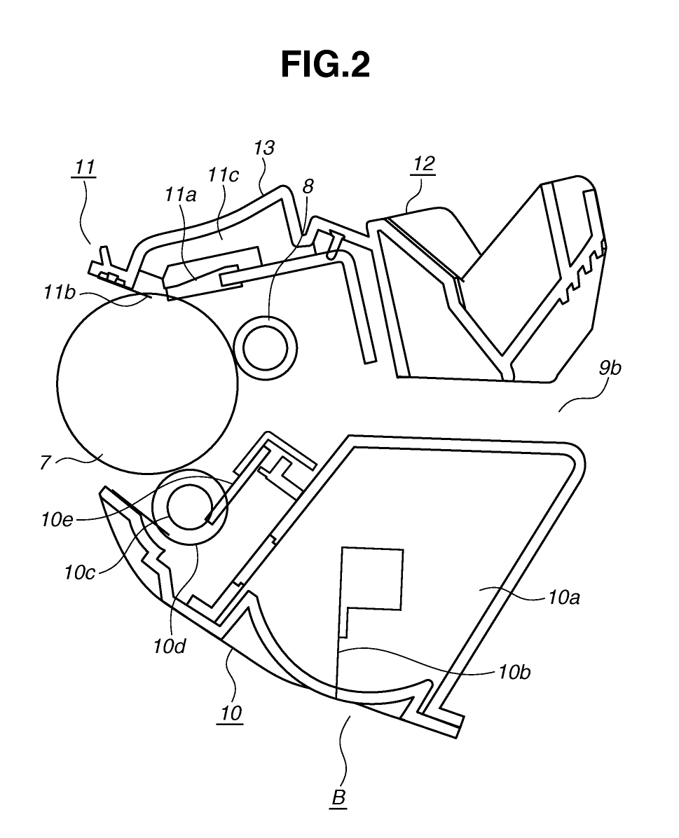

First of all, an overall configuration of the image forming apparatus main body and the process cartridge is schematically described with reference to FIGS. 1 and 2. FIG. 1 is a schematic cross-sectional view illustrating the overall configuration of a laser beam printer (hereinafter, referred to as an “image forming apparatus main body”) as one example of the image forming apparatus main body. FIG. 2 is a schematic cross-sectional view illustrating the process cartridge.

In an image forming apparatus main body A, an electrophotographic photosensitive member (image bearing member, hereinafter, referred to as “photosensitive drum”) 7 having a drum shape is irradiated with information light which is generated based on image information from an optical system 1 as an optical unit, as illustrated in FIG. 1. As a result, an electrostatic latent image is formed on the photosensitive drum 7, and is developed by a developer (hereinafter, referred to as “toner”), whereby a toner image is formed. Recording media (a recording sheet, an overhead projector (OHP) sheet, cloth, and the like) 2 are separated from each other to be fed one by one from a feeding unit (cassette) 3a, by a pickup roller 3b and a pressure contact member 3c in pressure contact with the pickup roller 3b, in synchronization with the toner image forming. A transfer roller 4, as a transfer unit, applies voltage to the recording medium 2 conveyed along a conveyance guide 3f1. As a result, the toner image formed on the photosensitive drum 7 of a process cartridge B is transferred onto the recording medium 2. The recording medium 2, on which the toner image has been transferred, is conveyed along a conveyance guide 3f2 to a fixing unit 5. The fixing unit 5 incorporates a driving roller 5a and heater 5b, and includes a fixing rotational member 5d. The fixing rotational member 5d is formed by a cylinder shaped sheet which is rotatably supported by a supporting member 5c. The fixing unit 5 applies heat and pressure on the recording medium 2 passing therethrough, so that the transferred toner image is fixed. The recording medium 2 on which the transferred toner image has been fixed is conveyed by discharge rollers 3d to be discharged onto a discharge portion 6. A conveyance unit 3 is not limited to an above-described configuration including the pickup roller 3b, the pressure contact member 3c, the discharge rollers 3d, and the like.

### (Process Cartridge Configuration)

The process cartridge B includes the photosensitive drum 7 and at least one process unit, as illustrate in FIG. 2. For example, the process unit includes a charging unit that charges the photosensitive drum 7, a developing unit that develops the electrostatic latent image formed on the photosensitive drum 7, and a cleaning unit that removes toner remaining on the photosensitive drum 7. As illustrated in FIG. 2, in the process cartridge B, the photosensitive drum 7 serving as the electrophotographic photosensitive member including a photosensitive layer is driven to be rotated, and voltage is applied to a charging roller 8 serving as the charging unit to uniformly charge the surface of the photosensitive drum 7. The charged photosensitive drum 7 is exposed with the information light (optical image) which is emitted based on the image information from the optical system 1 disposed in the image forming apparatus main body A through an exposure opening 9b. Thus, the electrostatic latent image is formed on the surface of the photosensitive drum 7. Then, the electrostatic latent image is developed by the developing unit.

In the developing unit, toner in a toner containing unit 10a is fed by a rotatable feeding member 10b as a toner feeding unit. Then, while a developing roller 10d is being rotated, a toner layer, frictionally charged by a developing blade 10e, is formed on the surface of the rotating developing roller 10d. The developing roller 10d serving as a developing rotating body (developer bearing member) incorporates a fixed magnet piece 10c. As a result, the toner on the surface of the developing roller 10d is transferred onto the photosensitive drum 7 in accordance with the electrostatic latent image, whereby the electrostatic latent image is visualized as a toner image. Then, the toner image formed on the surface of the photosensitive drum 7 is transferred onto the recording medium 2 by applying voltage with the same polarity as the toner image to the photosensitive drum 7.

Then, the toner remaining on the photosensitive drum 7 is scraped off by a cleaning member 11a serving as a cleaning unit, while being prevented from leaking out of a waste toner containing unit 11c by a scooping sheet 11b.

The process cartridge B includes two main units, namely, a photosensitive drum unit 11 and a development unit 10. The photosensitive drum unit 11 includes the photosensitive drum 7, the charging roller 8 as the charging unit, the cleaning member 11a as the cleaning unit, the scooping sheet 11b, and a cleaning frame unit 12. The development unit 10 includes the developing unit.

### (Sealing Configuration for Cleaning Frame Unit)

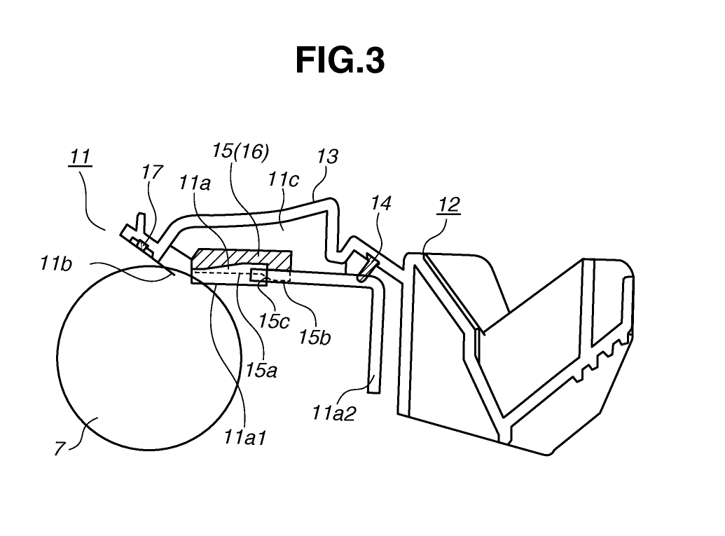

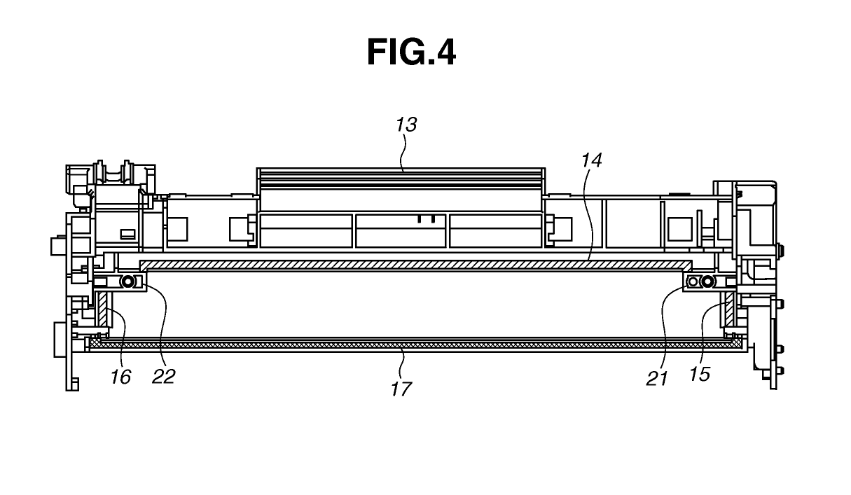

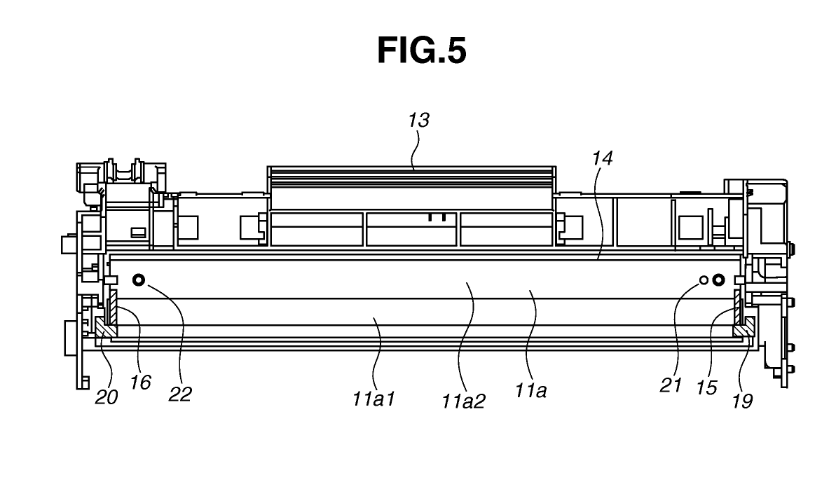

Next, a sealing configuration of the cleaning frame unit 12 according to the present exemplary embodiment is described in detail with reference to FIGS. 3 to 5. FIG. 3 is a schematic cross-sectional view illustrating the photosensitive drum unit 11 according to the present exemplary embodiment. FIG. 4 is a schematic front view illustrating the sealing configuration of the cleaning frame unit 12 according to the present exemplary embodiment. FIG. 5 is a schematic front view illustrating the cleaning frame unit 12 in a state where the cleaning member 11a according to the present exemplary embodiment is attached.

As illustrated in FIGS. 3 and 4, the cleaning frame unit 12 includes a cleaning container 13 (frame), a blade lower sealing member 14 (sealing member), and vertical sealing members 15 and 16. The cleaning member 11a includes a blade 11a1, which is made of an elastic member such as rubber and faces the photosensitive drum 7, and a supporting portion 11a2 which is made of a plate and the like fixed to the cleaning container 13 and supports the blade 11a1. The blade lower sealing member 14 extends in a longitudinal direction over between blade attached seating surfaces 21 and 22 disposed at both end portions of the cleaning container 13 in the longitudinal direction. The vertical sealing members 15 and 16 extend in a direction intersecting with the longitudinal direction, and are disposed at end portions of the cleaning container 13 in the longitudinal direction and between the cleaning container 13 and the supporting portion 11a2. Thus, a gap between the cleaning container 13 and the cleaning member 11a is sealed by the blade lower sealing member 14 and the vertical sealing members 15 and 16, and a waste toner containing unit 11c, as a space where the waste toner is stored, is formed. More specifically, with the blade lower sealing member 14 and the vertical sealing members 15 and 16, the waste toner in the waste toner containing unit 11c can be prevented from leaking through the gap between the cleaning member 11a and the cleaning container 13. The cleaning frame unit 12 is provided with a fixing member 17 that fixes the scooping sheet 11b to the cleaning container 13.

Next, the blade lower sealing member 14 is described more in detail. As illustrated in FIG. 3, the blade lower sealing member 14 has a shape extending toward the cleaning member 11a. More specifically, the blade lower sealing member 14 has a shape protruding in a direction angled (inclined) with respect to a direction perpendicular to the cleaning member 11a by a predetermined angle. Similarly, the blade lower sealing member 14 is formed in a shape protruding in a direction intersecting with a demolding direction of the cleaning container 13. The blade lower sealing member 14 which diagonally extends has a distal end with a round shape in a cross-section orthogonal to the longitudinal direction, to stabilize the contact with the cleaning member 11a. The blade lower sealing member 14 is formed by integrally injection molding with the cleaning container 13 using an elastic sealing member. Elastomer resin is used as a material of the elastic sealing member. The elastomer resin is preferably a resin material that is similar to the material of the cleaning container 13. Thus, the cleaning container 13 and the blade lower sealing member 14 can be recycled without being separated from each other. For this reason, elastic styrene elastomer, which is made of a material similar to that of the cleaning container 13 is used. The resin material which can be used for the blade lower sealing member 14 is not limited to this. The resin material may be any other elastomer resin with a similar mechanical characteristic, and may be silicone rubber, soft rubber or the like. In this specification, various types of elastomer resin and rubber serving as the elastic sealing member described above are collectively referred to as “elastomer resin”.

(Process of Integrally Molding Blade Lower Sealing Member with Cleaning Container)

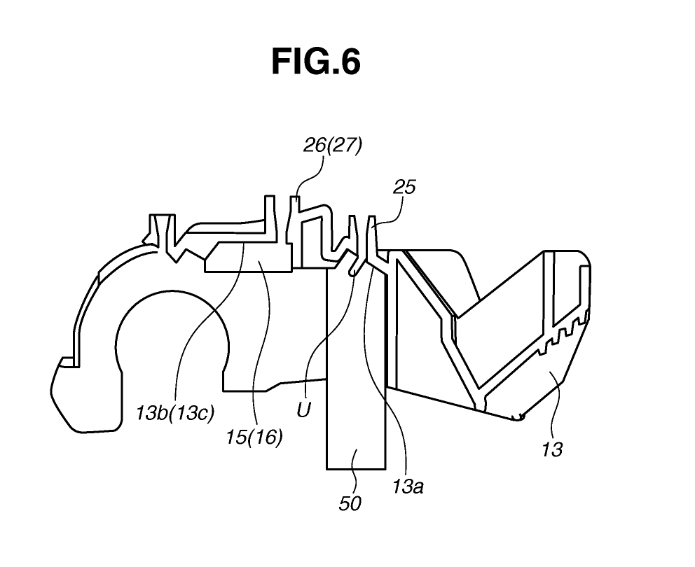

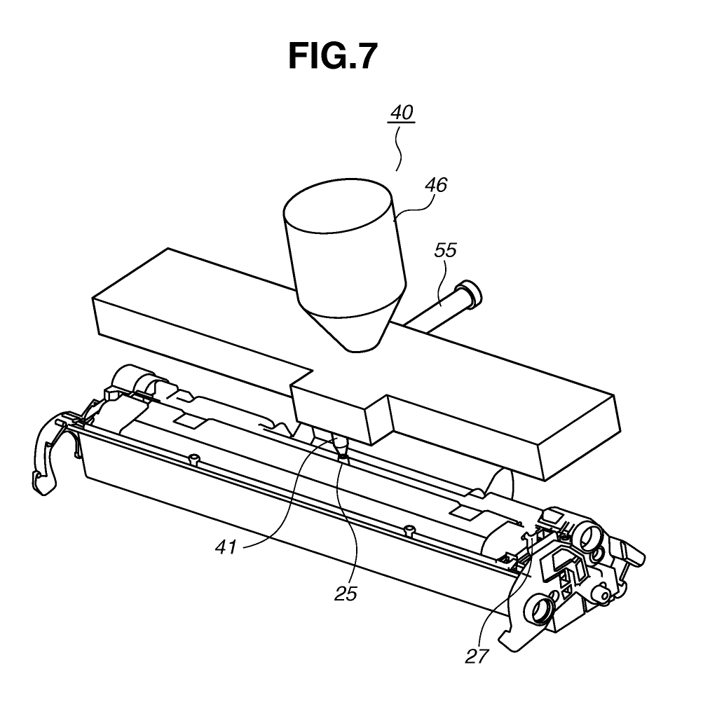

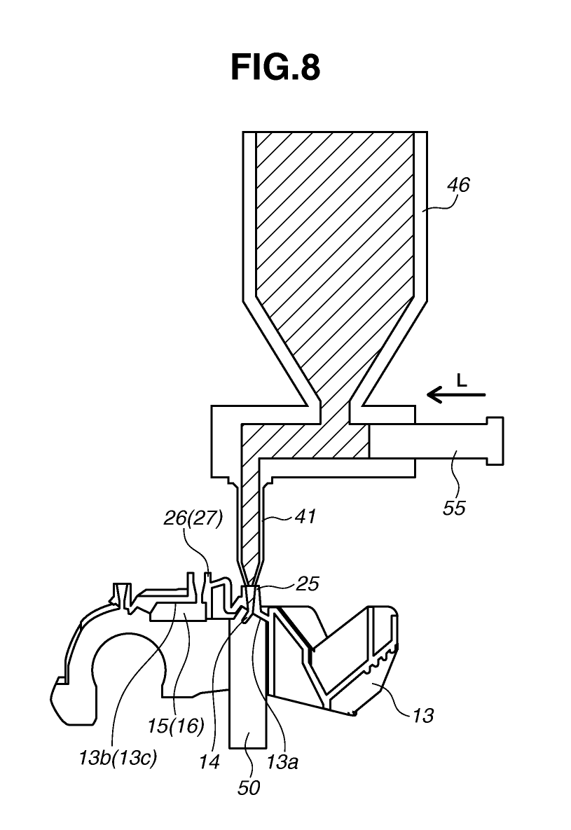

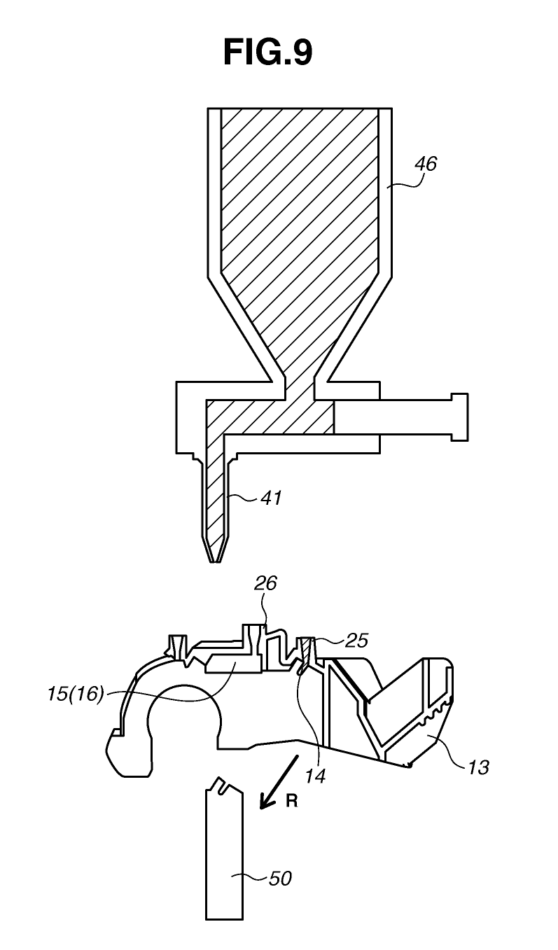

Next, a process of integrally molding the blade lower sealing member 14 with the cleaning container 13 will be described with reference to FIGS. 6 to 9. FIG. 6 is a schematic cross-sectional view illustrating an injection port of a cleaning container according to the present exemplary embodiment. FIG. 7 is a perspective view illustrating a state where the cleaning container 13 is set to the resin injection device 40, according to the present exemplary embodiment. FIG. 8 is a schematic cross-sectional view illustrating a state where resin is injected to the cleaning container 13, according to the present exemplary embodiment. FIG. 9 is a schematic cross-sectional view illustrating a state after the resin is injected to the cleaning container 13, according to the present exemplary embodiment.

The cleaning container 13 is set to the resin injection device 40. A lower sealing member mold 50, which is curved to have the shape of the blade lower sealing member 14, is attached to the resin injection device 40. As illustrated in FIG. 6, the lower sealing member mold 50 is brought into contact with the blade lower sealing member 14 and is mold clamped. Thus, a space U for forming the blade lower sealing member 14 is formed between the lower sealing member mold 50 and a mold contact surface 13a of the cleaning container 13, which comes into contact with the lower sealing member mold 50. In addition to the mold contact surface 13a, the cleaning container 13 is provided with an injection port 25 as an injection portion through which a molten resin for forming the lower sealing member 14 is injected. The injection port 25 is formed through the cleaning container 13 to be in communication with the space U in which the blade lower sealing member 14 is formed.

The resin injection device 40 further includes a gate 41 through which a molten resin material to be the blade lower sealing member 14 is injected, a hopper unit 46 from which the molten resin material is supplied to the gate 41, and a plunger 55 with which a predetermined amount of the molten resin material is injected through the gate 41. As illustrated in FIG. 7, the gate 41 is moved to a position to be in contact with the injection port 25. The gate 41 is disposed at a position matching and facing the injection port 25. As illustrated in FIG. 8, the plunger 55 is driven in a direction indicated by an arrow L. As a result, the molten resin material is injected to the injection port 25 through the gate 41, flows into the space U formed with the cleaning container 13 and the lower sealing member mold 50, and then the blade lower sealing member 14 is formed. In the configuration described above, the injection port 25 is formed at a single position at the center of the lower sealing member mold 50, in other words, blade lower sealing member 14 in the longitudinal direction. However, it is not limited thereto. Alternatively, the injection ports 25 may be disposed at two or more positions in such a manner that the flow lengths of the injected resin become equal at both positions.

After the injection is completed, the gate 41 is retracted from the injecting position, and the cleaning container 13 is detached from the lower sealing member mold 50. More specifically, as illustrated in FIG. 9, the cleaning container 13 is retracted downward in FIG. 9 from the gate 41 of the resin injection device 40, and then the lower sealing member mold 50 is retracted in a direction indicated by an arrow R from the cleaning container 13. The direction indicated by the arrow R is a demolding direction involving no undercut portion on the shape of the molded blade lower sealing member 14. By retracting the lower sealing member mold 50 in the direction indicated by the arrow R, the blade lower sealing member 14 can be taken out in state of being integrally molded with the cleaning container 13.

Through the procedure described above, the blade lower sealing member 14 can be integrally molded with the cleaning container 13, and thus can be disposed on the cleaning container 13 with high position accuracy. Similarly, a mold (not illustrated) is brought into contact with mold contact surfaces 13b and 13c, and the molten resin material is injected through injection ports 25 and 26, whereby the vertical sealing members 15 and 16 are integrally injection molded with the cleaning container 13.

### (Cartridge Remanufacturing Method)

A first exemplary embodiment of the present invention is described below. First, the cartridge remanufacturing method is described.

The cartridge B with the toner in the toner containing unit 10a used up is collected and remanufactured. In the remanufacturing, a disassembled component is inspected, and if rejected, appropriate measures are taken, such as replacement with a new one.

(Process for Separating Development Unit from Photosensitive Drum Unit)

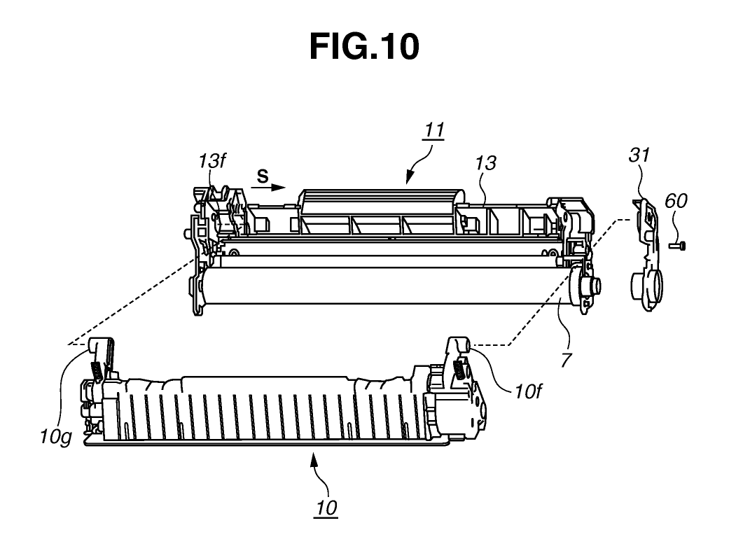

A process for separating the development unit 10 from the photosensitive drum unit 11 is described with reference to FIG. 10. FIG. 10 is a perspective view illustrating a state where the development unit 10 is separated from the photosensitive drum unit 11.

First of all, a side holder member 31 is detached from the photosensitive drum unit 11. The side holder member 31 is fixed to one end of the photosensitive drum unit 11 (hereinafter, referred to as “one end”) in the longitudinal direction with a screw 60. The screw 60 is removed, and then the side holder member 31 is detached from the photosensitive drum unit 11. On the side of the one end, the side holder member 31 supports a swinging shaft unit 10f of the development unit 10 in a swingable manner with respect to the photosensitive drum unit 11, and also rotatably supports the photosensitive drum 7. On the side of the other end in the longitudinal direction (hereinafter, referred to “the other end”), the swinging shaft unit 10g of the development unit 10 is inserted and fit in a swing movement hole portion 13f of the photosensitive drum unit 11, so as to make the development unit 10 swingable with respect to the photosensitive drum unit 11. Accordingly, the fitting is released by sliding the development unit 10 toward the one end side (in a direction indicated by an arrow S). As described above, the development unit 10 can be separated from the photosensitive drum unit 11 on the one end side by detaching the side holder member 31. More specifically, after the side holder member 31 has been detached, the development unit 10 is slid to the one end side so that the fitting at the fitting portion is released, and the development unit 10 is separated and detached from the photosensitive drum unit 11. This concludes the process of detaching the development unit.

### (Process for Detaching Photosensitive Drum and Charging Roller)

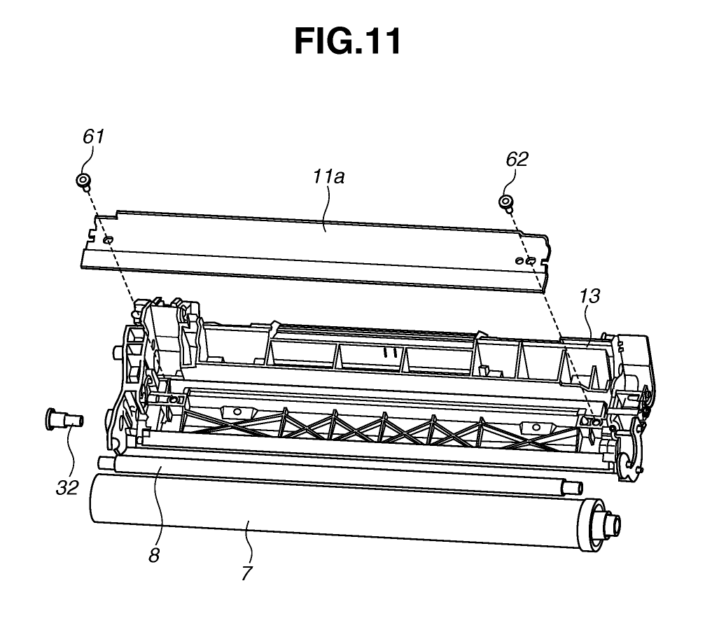

Next, a process for detaching the photosensitive drum 7 and the charging roller 8 will be described with reference to FIG. 11. FIG. 11 is a perspective view illustrating a state where the photosensitive drum 7, the charging roller 8, and the cleaning member 11a are detached from the photosensitive drum unit 11.

The photosensitive drum 7 has one end side rotatably supported by the side holder member 31, and the other end side rotatably supported by a drum shaft 32 press fitted and fixed to the cleaning container 13. Since the side holder member 31 has been detached as described above, the one end side of the photosensitive drum 7 is not fixed by the cleaning container 13. On the other end side, the drum shaft 32, which is press fit to the cleaning container 13, is pulled out by using a tool such as a pair of pliers, so that the cleaning container 13 and the photosensitive drum 7 can be separated from each other. Then, the photosensitive drum 7 is detached, and the process for detaching the photosensitive drum 7 is completed. After the photosensitive drum 7 is removed, the charging roller 8 is detached from charging roller supporting units 33 and 34.

### (Process for Detaching Cleaning Member)

Next, a process for detaching the cleaning member 11a is described with reference to FIG. 11.

The cleaning member 11a can be detached after the charging roller 8 is detached. First of all, screws 61 and 62 with which the cleaning member 11a is fixed to the cleaning container 13 are removed. Then, the cleaning member 11a is detached from the cleaning container 13, whereby the process for detaching the cleaning member 11a is completed.

### (Process for Cleaning Cleaning Container)

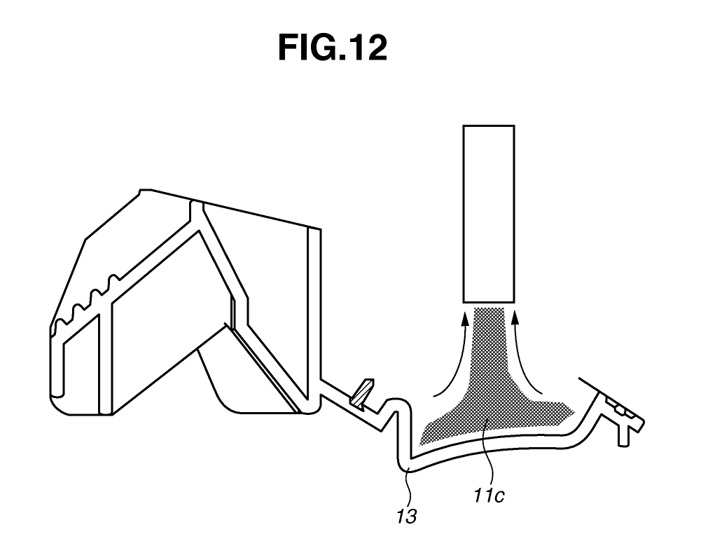

Next, a process for cleaning the cleaning container 13 (frame cleaning process) is described with reference to FIG. 12. FIG. 12 is a schematic diagram illustrating the process for cleaning the cleaning container 13.

In the cartridge B with the toner in the toner containing unit 10a used, the waste toner, as the residual developer on the photosensitive drum 7 removed by the cleaning member 11a, is collected in the waste toner containing unit 11c of the cleaning container 13. The waste toner is sucked up and removed by a suction device such as a vacuum cleaner, so that the waste toner containing unit 11c of the cleaning container 13 is cleaned, whereby the process of cleaning the cleaning container 13 is completed.

### (Process for Cleaning Blade Lower Sealing Member)

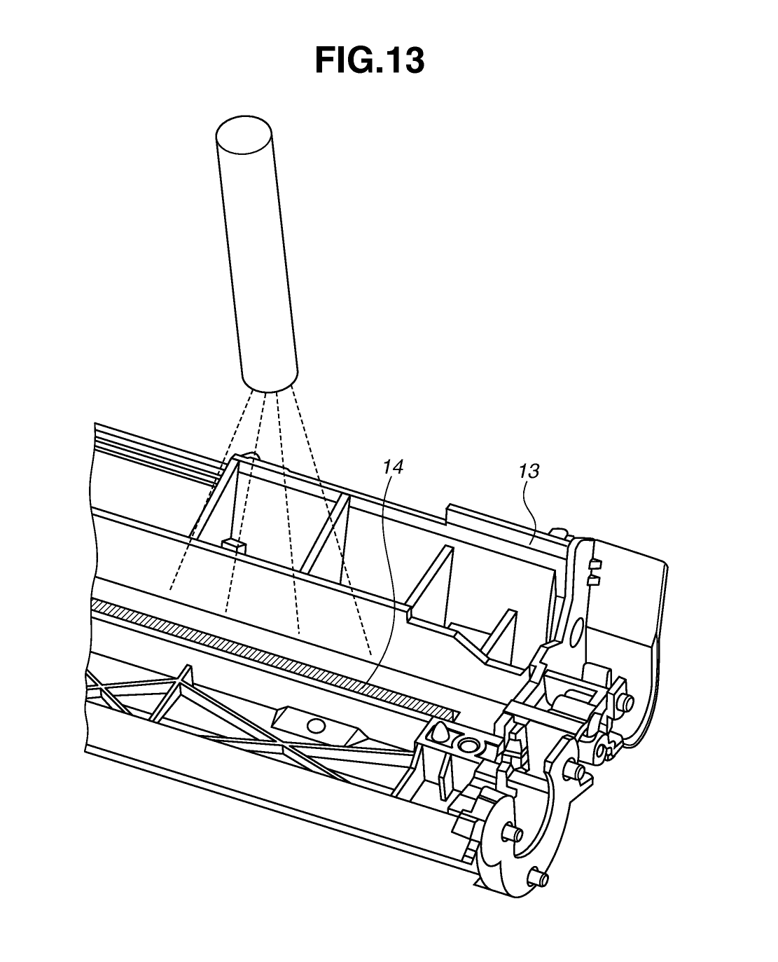

Next, a process for cleaning the blade lower sealing member 14 will be described with reference to FIG. 13. FIG. 13 is a schematic view illustrating the process for cleaning the blade lower sealing member 14.

As described above, the blade lower sealing member 14 is a lip shaped sealing member formed on the cleaning container 13 through injection molding using the elastomer resin. The blade lower sealing member 14 can be reused by cleaning the toner attached on the surface thereof by blowing air or wiping the surface with cloth which may or may not contain alcohol. This concludes the process of cleaning the blade lower sealing member 14.

### (Process for Attaching Cleaning Member)

First, a process for attaching the cleaning member 11a is described as the first process for reassembling the photosensitive drum unit 11. The attaching process, which is carried out in the reverse order to that of detaching the cleaning member 11a, is described with reference to FIG. 11.

Toner and paper powder on the cleaning member 11a which has been detached is cleaned by blowing air or the like. The resultant cleaning member 11a is inspected, and if rejected, appropriate measures are taken, such as replacement with a new one. Then, the cleaning member 11a is fastened at predetermined position of the cleaning container 13 with a screw. More specifically, the cleaning member 11a is fastened to the cleaning container 13 with the screws 61 and 62, with the blade lower sealing member 14 bending on the cleaning member 11a. This concludes process for attaching the cleaning member 11a.

Thereafter, the photosensitive drum unit 11 is assembled in the reverse order to that of disassembling the photosensitive drum unit 11. When the toner, the paper powder, and the like are attached on the surface of the detached charging roller 8, the surface is cleaned by blowing air and the like as appropriate. Then, the charging roller 8 is inspected, and if rejected, appropriate measures are taken, such as replacement with a new one. The photosensitive drum unit 11, the side holder member 31, and the drum shaft 32 are similarly processed. More specifically, the components are inspected after being cleaned by blowing air and the like when the toner and the like are attached. If components are rejected on the inspection, appropriate measures are taken, such as replacement with a new one. Then, the components are attached in the reverse order to that of disassembling the photosensitive drum unit 11.

After the photosensitive drum unit 11 is assembled, the photosensitive drum unit 11 and the development unit 10 are coupled to each other in the reverse order to that given in the process for separating the photosensitive drum unit 11 and the development unit 10 from each other. The development unit 10 is refilled with toner, after or, desirably, before the development unit 10 is coupled to the photosensitive drum unit 11. As described above, the used cartridge B can be easily remanufactured to be a cartridge that is as good as new with the developer leakage more effectively prevented.

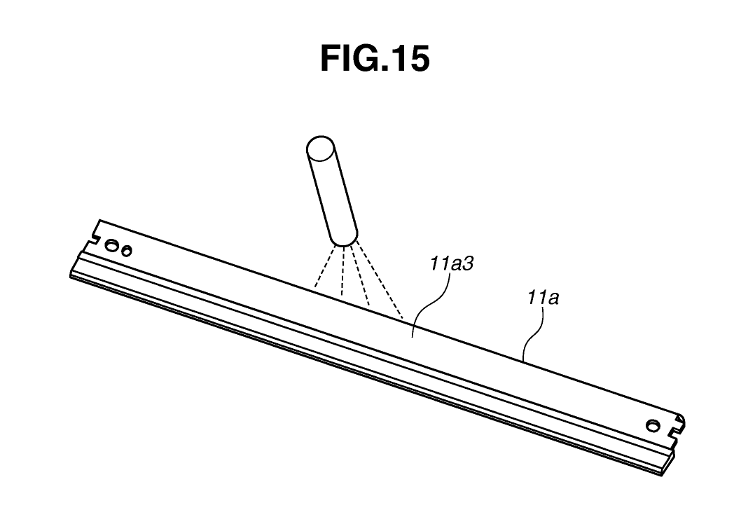

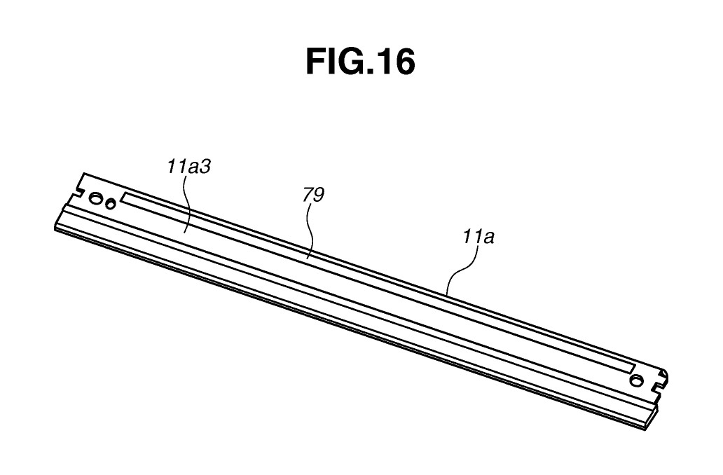

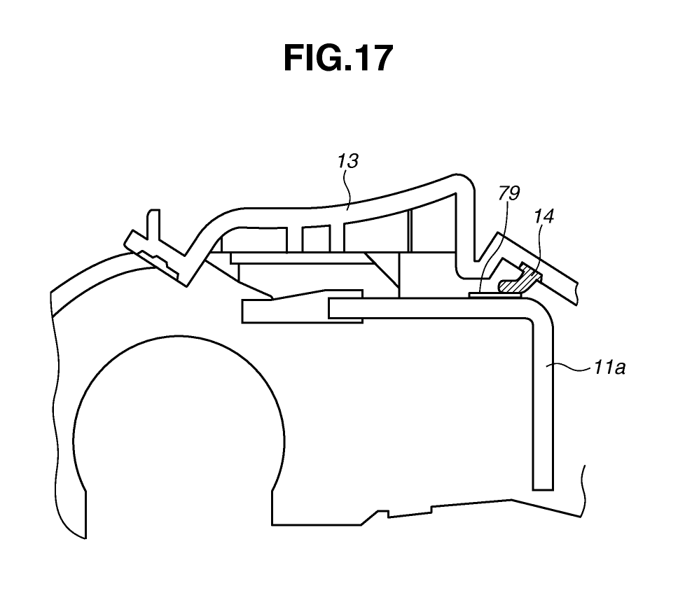

A second exemplary embodiment of the present invention is described below with reference to FIGS. 15, 16 and 17. FIG. 15 is a schematic view illustrating a process for cleaning the cleaning member 11a. FIG. 16 is a schematic perspective view illustrating a state where an assisting member 79 is attached on the cleaning member 11a. FIG. 17 is a schematic cross-sectional view illustrating a state where the cleaning member 11a on which the auxiliary member 79 is attached is attached to a cleaning frame unit 12. The second exemplary embodiment is only different from the first embodiment in the process for cleaning the cleaning member 11 and in a process for fixing the assisting member 79 on the cleaning member 11a, and the other processes are sequentially executed as in the first exemplary embodiment. Thus, the second exemplary embodiment is described below mainly focusing on the difference from the first exemplary embodiment.

### (Process for Cleaning Cleaning Member)

After the process for detaching the cleaning member 11a, as illustrated in FIG. 15, the toner attached to the detached cleaning member 11a on the surface 11a3 that is in contact with the blade lower sealing member 14 is cleaned by blowing air or the like. More specifically, the surface 11a3 refers to the surface of the supporting portion 11a2 of the cleaning member 11a, which faces the cleaning container 13. The surface 11a3 is cleaned by blowing air or by wiping, for example, with cloth containing alcohol. This concludes the process for cleaning the cleaning member 11a.

### (Process for Fixing Assisting Member to Cleaning Member)

Next, as illustrated in FIG. 16, the assisting member is attached to and fixed on the surface 11a3 of the cleaning member 11a which has been cleaned. In the present exemplary embodiment, a double-sided tape 79 is used. This concludes the process for fixing the assisting member 79 on the cleaning member 11a.

Then, the process for attaching the cleaning member 11a is performed as in the first exemplary embodiment. As illustrated in FIG. 17, the cleaning member 11a is attached to the cleaning container 13 in such a manner that the blade lower sealing member 14 is bent on the cleaning member 11a. More specifically, the blade lower sealing member 14 is in contact with the double-sided tape 79 on the cleaning member 11a. After the process for attaching the cleaning member 11a, the photosensitive drum unit 11 and the cartridge are sequentially assembled, whereby the cartridge is remanufactured.

With the double-sided tape 79 provided between the blade lower sealing member 14 and the cleaning member 11a, a strong contact state between the blade lower sealing member 14 and the cleaning member 11a can be achieved. Meanwhile, the contact pressure of the blade lower sealing member 14 to the cleaning member 11a might be reduced by, for example, creep deformation after the cleaning member 11a is detached. However, the contact pressure can be assisted with the adhesiveness and the thickness of the double-sided tape 79, whereby the contact state can become stronger. Accordingly, it is particularly desirable to use the double-sided tape 79 in remanufacturing. By attaching the assisting member 79 to the cleaning member 11a, the waste toner can be more effectively prevented from leaking out of the cleaning frame unit 12.

In the present exemplary embodiment, while the process for cleaning the blade lower sealing member 14 is performed, it is not limited thereto. This process may be omitted. The process for cleaning the blade lower sealing member 14 is desirably performed as appropriate when the waste toner scatters in the process for detaching the cleaning member 11a and the like. In the present exemplary embodiment, while the double-sided tape 79 is used as the assisting member, it is not limited thereto. Any member that can be fixed to the blade lower sealing member 14 can be used. More specifically, a sheet shaped member that can be attached to the blade lower sealing member 14 and the like can be used. For example, as the assisting member 79, a one-sided tape as well as adhesive styrene elastomer resin that is the same material as that of the blade lower sealing member 14 may be used. Furthermore, other adhesive elastomer resin with which the strong contact state between the blade lower sealing member 14 and the cleaning member 11a can be achieved may be used.

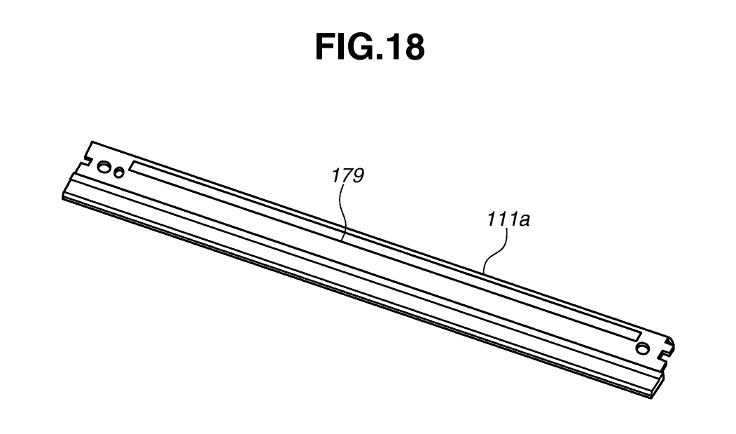

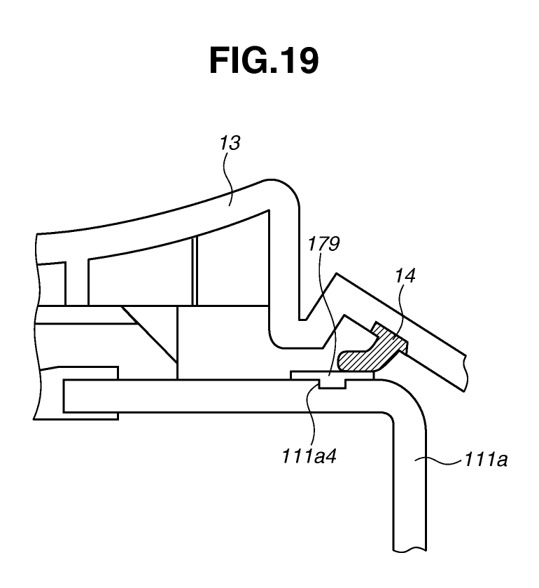

The cleaning member 11a on which the assisting member 79 is attached as in the second exemplary embodiment can be used not only in the case where the cartridge is remanufactured, and can also be used in a case where a new cartridge is manufactured. A specific configuration according to such a modified embodiment is described with reference to FIGS. 18 and 19. FIG. 18 is a schematic perspective view illustrating the cleaning member 11a on which an assisting member 179 is attached. FIG. 19 is a schematic cross-sectional view illustrating a state where the cleaning member 11a according to the present modified embodiment is attached to the cleaning container 13. The present modified embodiment is described below focusing on differences from the cartridge described above.

As illustrated in FIG. 18, the cleaning member 111a with the double-sided tape 179 as the assisting member attached on the surface of the cleaning member 111a is prepared. Then, the cleaning member 111a is attached to the cleaning container 13 in such a manner that the blade lower sealing member 14 is bent on the cleaning member 111a, as in the case illustrated in FIG. 17. After the charging roller 8 is assembled to the cleaning container 13, the photosensitive drum 7 is fixed by the side holder member 31 and the drum shaft 32 and is integrated with the development unit 10 so that the cartridge B is formed as in the case described above.

In the configuration according to the present modified embodiment, the blade lower sealing member 14 comes into contact with the double-sided tape 179 on the cleaning member 111a. As a result, with the double-sided tape 79 provided in between, the strong contact state between the blade lower sealing member 14 and the cleaning member 111a can be achieved. More specifically, the contact pressure can be assisted with the adhesiveness and the thickness of the double-sided tape 179, whereby the strong contact state can be achieved. Consequently, the waste toner can be more effectively prevented from leaking out of the cleaning frame unit 12.

While the double-sided tape is used as the assisting member 179 also in the present modified embodiment, it is not limited thereto. Any member that can be fixed to the blade lower sealing member 14 can be used. More specifically, a sheet shaped member that can be attached to the blade lower sealing member 14 and the like can be used. For example, as the assisting member 179, a one-sided tape having adhesives only on one side as well as adhesive styrene elastomer resin that is the same material as that of the blade lower sealing member 14 may be used. Furthermore, other adhesive elastomer resin may be used.

When the elastomer resin is used as the assisting member 179, the assisting member 179 may be formed by injection molding using the elastomer resin on the cleaning member 111a. In this case, to prevent the positions of the cleaning member 111a and the assisting member 179 from mismatching, a recess 111a4 such as a hole is desirably formed in the cleaning member 111a as illustrated in FIG. 19 so that the elastomer resin enters into the recess 111a4. More desirably, a plurality of the recesses 111a4 is disposed along the longitudinal direction of the cleaning member 111a and extends in the longitudinal direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-228476, filed Nov. 10, 2014, which is hereby incorporated by reference herein in its entirety.

What is claimed is:

1. A method for remanufacturing a cleaning device including: an image bearing member; a frame configured to rotatably support the image bearing member; a cleaning member fixed to the frame and configured to clean a surface of the image bearing member; and a sealing member integrally injection molded with the frame and disposed between the frame and the cleaning member, the method, sequentially performed, comprising:
detaching the cleaning member from the frame;
cleaning the sealing member; and
attaching the cleaning member to the frame.

2. A method for remanufacturing a cleaning device including: an image bearing member; a frame configured to rotatably support the image bearing member; a cleaning member fixed to the frame and configured to clean a surface of the image bearing member; and a sealing member integrally injection molded with the frame and disposed between the frame and the cleaning member, the method, sequentially performed, comprising:
detaching the cleaning member from the frame;
fixing an assisting member on the cleaning member; and
attaching the cleaning member to the frame in such a manner that the assisting member comes into contact with the sealing member.

3. The method for remanufacturing the cleaning device according to claim 2, further comprising cleaning a surface of the cleaning member to which the assisting member is attached after the detaching of the cleaning member and before the fixing of the assisting member.

4. The method for remanufacturing the cleaning device according to claim 2,
wherein the cleaning member includes a cleaning blade configured to contact the image bearing member, and a supporting portion fixed to the frame and configured to support the cleaning member, and
wherein the assisting member is attached to the supporting portion in the fixing of the assisting member.

5. The method for remanufacturing the cleaning device according to claim 4, wherein the assisting member is a double-sided tape that is attached to the supporting portion in the fixing of the assisting member and is attached to the sealing member in the attaching of the cleaning member.

6. The method for remanufacturing the cleaning device according to claim 4, wherein the assisting member is elastomer resin and is integrally formed with the supporting portion in the fixing of the assisting member.

7. The method for remanufacturing the cleaning device according to claim 6,
wherein the supporting portion includes a recess, and
wherein the assisting member is formed by the elastomer resin flowing into the recess.

8. The method for remanufacturing the cleaning device according to claim 2, further comprising cleaning the sealing member performed after the detaching of the cleaning member and before the attaching of the cleaning member.

9. The method for remanufacturing the cleaning device according to claim 1, further comprising cleaning the frame by removing a developer accumulated between the frame and the cleaning member, performed after the detaching of the cleaning member and before the attaching of the cleaning member.

10. The method for remanufacturing the cleaning device according to claim 1, wherein a longitudinal direction of the sealing member matches a rotational axis direction of the image bearing member.

11. A method for remanufacturing a cartridge including: a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member; and a developing device configured to develop an electrostatic latent image formed on the image bearing member, the method, sequentially performed, comprising:
separating the cartridge into the cleaning device and the developing device;
detaching the cleaning member from the frame of the cleaning device;
cleaning the sealing member; and
attaching the cleaning member to the frame.

12. A method for remanufacturing a cartridge including: a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member; and a developing device configured to develop an electrostatic latent image formed on the image bearing member, the method, sequentially performed, comprising:
separating the cartridge into the cleaning device and the developing device;
detaching the cleaning member from the frame of the cleaning device;
fixing an assisting member to the cleaning member; and
attaching the cleaning member to the frame in such a manner that the assisting member comes into contact with the sealing member that are performed.

13. The method for remanufacturing the cartridge according to claim 12, further comprising cleaning a surface of the cleaning member to which the assisting member is attached, after the detaching of the cleaning member and before the fixing of the assisting member.

14. The method for remanufacturing the cartridge according to claim 12,
wherein the cleaning member includes a cleaning blade configured to contact the image bearing member and a supporting portion fixed to the frame and configured to support the cleaning blade, and
wherein the assisting member is attached to the supporting portion in the fixing of the assisting member.

15. The method for remanufacturing the cartridge according to claim 14, wherein the assisting member is a double-sided tape that is attached to the supporting portion in the fixing of the assisting member and is attached to the sealing member in the attaching of the cleaning member.

16. The method for remanufacturing the cartridge according to claim 14, wherein the assisting member is elastomer resin and is integrally formed with the supporting portion in the fixing of the assisting member.

17. The method for remanufacturing the cartridge according to claim 16,
wherein the supporting portion includes a recess, and
wherein the assisting member is formed by the elastomer resin flowing into the recess.

18. The method for remanufacturing the cartridge according to claim 12, further comprising cleaning the sealing member performed after the detaching of the cleaning member and before the attaching of the cleaning member.

19. The method for remanufacturing the cartridge according to claim 11, further comprising cleaning the frame by removing a developer accumulated between the frame and the cleaning member, performed after the detaching of the cleaning member and before the attaching of the cleaning member.

20. The method for remanufacturing the cartridge according to claim 11, wherein a longitudinal direction of the sealing member matches a rotational axis direction of the image bearing member.

21. A cleaning device comprising:
an image bearing member;
a frame configured to rotatably support the image bearing member;
a cleaning member fixed to the frame and configured to clean a surface of the image bearing member; and
a sealing member integrally injection molded with the frame and disposed between the frame and the cleaning member,
wherein an assisting member is provided between the cleaning member and the sealing member.

22. The cleaning device according to claim 21,
wherein the cleaning member includes a cleaning blade configured to contact the image bearing member; and a supporting portion fixed to the frame and configured to support the cleaning blade, and
wherein the assisting member is attached to the supporting portion.

23. The cleaning device according to claim 21, wherein the assisting member is a double-sided tape.

24. The cleaning device according to claim 22, wherein the assisting member is elastomer resin and is integrally formed with the supporting portion.

25. The cleaning device according to claim 24,
wherein the supporting portion includes a recess, and
wherein the assisting member is formed by the elastomer resin flowing into the recess.

26. The cleaning device according to claim 21, wherein a longitudinal direction of the sealing member matches a rotational axis direction of the image bearing member.

27. A cartridge comprising:
a cleaning device including an image bearing member, a frame configured to rotatably support the image bearing member, a cleaning member fixed to the frame and configured to clean a surface of the image bearing member, and a sealing member integrally injection molded with the frame and disposed between the frame and the cleaning member; and
a developing device configured to develop an electrostatic latent image formed on the image bearing member,
wherein an assisting member is provided between the cleaning member and the sealing member.

28. The cartridge according to claim 27,
wherein the cleaning member includes a cleaning blade configured to contact the image bearing member and a supporting portion fixed to the frame and configured to support the cleaning blade, and
wherein the assisting member is attached to the supporting portion.

29. The cartridge according to claim 27, wherein the assisting member is a double-sided tape.

30. The cartridge according to claim 28, wherein the assisting member is elastomer resin and is integrally formed with the supporting portion.

31. The cartridge according to claim 30,
wherein the supporting portion includes a recess, and
wherein the assisting member is formed by the elastomer resin flowing into the recess.

32. The cartridge according to claim 27, a longitudinal direction of the sealing member matches a rotational axis direction of the image bearing member.
